(19) United States
(12) Patent Application Publication
(10) Pub. No.: US 2026/0145149 A1
(43) Pub. Date: May 28, 2026

(54) OSCILLATING EQUIPMENT

(71) Applicant: CHEMLEX PTE. LTD., SINGAPORE (SG)

(72) Inventors: Haibin XU, SINGAPORE (SG); Chao LU, SINGAPORE (SG); Xiaobiao ZHU, SINGAPORE (SG)

(73) Assignee: CHEMLEX PTE. LTD., SINGAPORE (SG)

(21) Appl. No.: 18/957,880

(22) Filed: Nov. 25, 2024

(51) Int. Cl. B01F 35/42; B01F 35/22; B01F 35/222; B01F 35/32

(52) U.S. Cl. CPC B01F 35/42; B01F 35/2209; B01F 35/222; B01F 35/3204

(57) ABSTRACT

The present disclosure provides an oscillating equipment, specifically related to the technical field of automation equipment. The oscillating equipment comprises a base comprising a guide structure provided along a first direction, a clamping mechanism, provided on the guide structure for clamping a container holding a reagent to be processed, a drive mechanism that is provided on a base and connected to the clamping mechanism via a first connecting rod, and a control mechanism, which is connected to the drive mechanism, for controlling the drive mechanism to work.

### FIELD

The present disclosure relates to the technical field of automation equipment, and in particular to an oscillating equipment.

### BACKGROUND OF THE DISCLOSURE

Chemical extraction is a common method to separate and purify compounds, which is realized by selective dissolution of solvents in different chemical properties. The extraction process is a physical process without chemical changes. There are various extraction methods, including liquid-liquid extraction, liquid-solid extraction (or leaching), gas-liquid extraction and gas-solid extraction.

Many samples in the laboratory need to oscillate, especially in the pre-treatment process of organic extraction, the need for sampling oscillation equipment for destructive pre-treatment of organic matter, the current general use of artificial hand-cranked oscillation, manual hand-cranked oscillation, the experimenter holds the sample oscillation equipment tube, swinging the arm up and down round-trip motion, drive by the sample tube of the sample to oscillate, the operation of the process in this way will result in the oscillation of the equipment experimenter High-intensity labor, and low efficiency.

### BRIEF SUMMARY OF THE DISCLOSURE

In order to be able to solve at least one of the above mentioned drawbacks of the prior art, the present disclosure provides an oscillation apparatus comprising:
a base, comprising a guide structure arranged in a first direction;
a clamping mechanism, provided on the guide structure, the clamping mechanism for clamping a container containing reagents to be processed; the reagents to be processed comprising a first reagent and a second reagent, the first direction being perpendicular to the contact surface between the first reagent and the second reagent;
a drive mechanism, provided on the base, the drive mechanism being connected to the clamping mechanism by means of a first connecting rod; the drive mechanism being connected to the first end of the first connecting rod, the second end of the first connecting rod being connected to the clamping mechanism, and the drive mechanism being used to drive the first end of the first connecting rod to perform a circular motion around the drive end of the drive mechanism, so as to cause the second end of the first connecting rod to drive the clamping mechanism to perform a round-trip motion along the guide structure;
a control mechanism, which is connected to the drive mechanism for controlling the drive mechanism to work.

Optionally, the driving mechanism is connected to the first end of the first connecting rod by a second connecting rod, the length of the second connecting rod matching the magnitude of motion of the clamping mechanism.

Optionally, the oscillating apparatus further comprises:
a limiting mechanism, provided on the base, the limiting mechanism comprising a first sensing device, the first output signal of the first sensing device indicating that the clamping mechanism is in an operative position, the operative position being the position at which the clamping mechanism completes the action of clamping or releasing the container.

Optionally, the clamping mechanism is provided with a slide on one side near the limiting mechanism, the first sensing device is used to output the first output signal when sensing the slide, and the location of the first sensing device is matched with the operation position.

Optionally, the limiting mechanism further comprises a first guide rail arranged along the first direction, the first sensing device being arranged in the first guide rail.

Optionally, the clamping mechanism comprises a clamping assembly, the clamping assembly comprising a second rail and an oppositely arranged clamping section, the clamping section being slidably arranged on the second rail, the distance between the oppositely arranged clamping sections being matched to the size of the container.

Optionally, the clamping mechanism comprises a plurality of the clamping assemblies.

Optionally, the guiding structure comprises a guide column provided along the first direction, the clamping mechanism being provided with a slider, the slider being socketed to the guide column.

Optionally, the control mechanism is further used to regulate the driving speed of the driving mechanism.

Optionally, the clamping mechanism is provided in a plurality, the driving mechanism is provided in a plurality, the plurality of the driving mechanisms correspond one to one with the plurality of the clamping mechanisms, each the driving mechanism being connected to a corresponding clamping mechanism.

By adopting the above technical solution, the present disclosure has the following beneficial effects:

The present disclosure provides an oscillating equipment comprising a base, a clamping mechanism, a drive mechanism, a limiting mechanism and a control mechanism, the base comprising a guide structure disposed along a first direction, the clamping mechanism being disposed on the guide structure for clamping a container holding a reagent to be processed, the reagent to be processed comprising a first reagent and a second reagent, and the first direction is perpendicular to the contact surface of the first reagent and the second reagent, so as to enable full contact of the two reagents during motion of the holding mechanism; the drive mechanism is provided on the base, the drive mechanism is connected to the clamping mechanism, the drive mechanism is connected to the first end of the first connecting rod, and the second end of the first connecting rod is connected to the clamping mechanism, and the drive mechanism is used to drive the first end of the first connecting rod to perform a circular motion around the drive end of the drive mechanism, so as to cause the second end of the first connecting rod drive the clamping mechanism to perform a round-trip motion along the guide structure, instead of manual oscillation, and to be able to meet the high-intensity operation and improve operational efficiency.

Other features and advantages of the present disclosure will be described in detail in the subsequent Embodiments.

### BRIEF DESCRIPTION OF THE DRAWINGS

In order to more clearly describe the technical solution in the embodiments of the present disclosure, the following will briefly introduce the drawings that need to be used in the description of the embodiments, and it will be obvious that the drawings in the following description are only some of the embodiments of the present disclosure, in which the same reference marks usually represent the same parts, and for the person of ordinary skill in the technical field, without putting in the creative labor, it is possible to obtain other drawings according to the drawings without putting in the creative labor.

FIG. 1 is a schematic diagram of a structure of an oscillation apparatus provided by an embodiment of the present disclosure;

FIG. 2 is a main view of an oscillation apparatus provided by an embodiment of the present disclosure;

FIG. 3 is a schematic diagram of a local structure of an oscillation apparatus provided by an embodiment of the present disclosure;

FIG. 4 is a schematic diagram of a localized structure of another oscillation apparatus provided by an embodiment of the present disclosure.

### DETAILED DESCRIPTION OF THE DISCLOSURE

The technical solutions in the present disclosure embodiments will be clearly and completely described below in conjunction with the accompanying drawings in the present disclosure embodiments. Obviously, the described embodiments are only a part of the embodiments of the present disclosure, and not all of the embodiments. All other embodiments obtained by those skilled in the art without creative effort based on the embodiments in the present disclosure fall within the scope of protection of the present disclosure.

“Embodiment” or “embodiments” used herein means a particular feature, structure or characteristic that may be included in at least one embodiment realization of the present disclosure. In the description of the present disclosure, it should be understood that the azimuth or positional relationship indicated by the terms “upper”, “lower”, “top” and “bottom” is based on the azimuth or positional relationship shown in the attached drawings, and is only for the convenience of describing the present disclosure and simplifying the description, and does not indicate or imply that the referred device or element must have a specific orientation, be constructed and operated in a specific orientation, so it cannot be understood as a limitation of the present disclosure. Furthermore, the terms “first” and “second” are used for descriptive purposes only and are not to be understood as indicating or implying relative importance or implicitly specifying the number of technical features indicated. Thus, a feature defined with the terms “first” and “second” may expressly or implicitly include one or more such features. Furthermore, the terms “first”, “second”, etc. are used to distinguish similar objects and need not be used to describe a particular order or sequence. It should be understood that the data so used may be interchanged, where appropriate, so that the embodiments of the present disclosure described herein can be embodied in an order other than those illustrated or described herein.

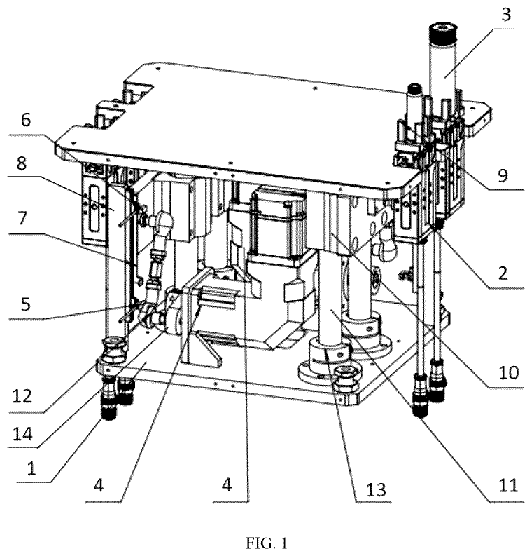

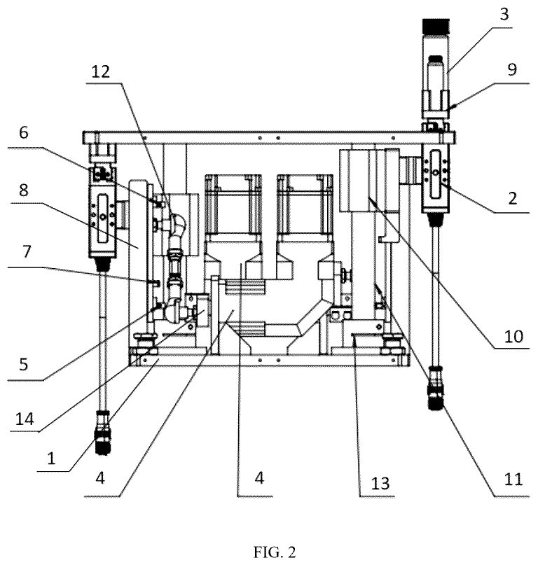

Reference is made to FIGS. 1-2, the present disclosure provides an oscillating equipment, comprising:
a base 1, comprising a guide structure arranged in a first direction. Specifically, base 1 includes a first mounting plate and a second mounting plate arranged opposite each other, the first mounting plate being parallel to the second mounting plate, the guide structure being arranged between the two mounting plates, the guide structure being perpendicular to the first mounting plate and the second mounting plate, i.e. the first mounting plate and the second mounting plate being perpendicular to the first direction respectively. In some specific embodiments, the guide structure can be arranged as a slide rail, guide post, etc., for guiding the motion of the clamping mechanism 2 in the first direction.
a clamping mechanism 2, provided on the guide structure, the clamping mechanism 2 is used to clamp a container 3 containing reagents to be processed; the reagents to be processed comprise a first reagent and a second reagent, a contact surface being formed between the first reagent and the second reagent, the first direction intersecting the contact surface, the first direction forms an angle with the contact surface, and the angle may take on different values. The first direction is the oscillation direction, preferably a direction that facilitates sufficient contact between the first reagent and the second reagent. For example, the first direction is perpendicular to the contact surface of the first reagent and the second reagent. In practice, the first reagent may comprise a plurality of reagents, and the second reagent may also comprise a plurality of reagents. The first reagent and the second reagent may take on various forms, such as solids, liquids, gases, etc. Specifically, the projection of the clamping mechanism 2 in the first direction does not intersect with either the first mounting plate or the second mounting plate, so as to prevent the first mounting plate or the second mounting plate from limiting the range of motion of the clamping mechanism 2. Specifically, the container 3 is sized to match the clamping mechanism 2, which can be configured as a gripper, and the opening of the gripper can be adjusted to accommodate containers 3 of different sizes. Specifically, the first reagent and the second reagent are the objects of extraction, and the present disclosure provides an oscillating equipment for oscillating the first reagent and the second reagent before extraction. In practice, the contact surface between the first reagent and the second reagent is usually horizontal, and accordingly, the first direction is the vertical direction. The clamping mechanism 2 moves along the vertical direction, so that the first reagent in the container 3 comes into sufficient contact with the second reagent. In specific embodiments, the contact surface between the first reagent and the second reagent may be non-planar, for example, in solid-liquid extraction, where one of the reagents is an irregular solid, the contact surface between the two reagents is not a plane, but an irregular surface. In this case, the average tangent plane of the irregular surface can be determined, and this average tangent plane can be used as the contact surface between the first reagent and the second reagent, and the first direction can be determined in the above manner. In practice, if the guide structure is set as a slide rail, the clamping mechanism 2 is slidably arranged on the slide rail, so that the clamping mechanism 2 moves along the slide rail; if the guide structure is set as a guide post, the clamping mechanism 2 is socketed to the guide post, so that the clamping mechanism 2 moves along the guide post.
a drive mechanism 4, provided on base 1, the drive mechanism 4 connected to the clamping mechanism 2 by means of a first connecting rod 12; the drive mechanism 4 connected to first end of first connecting rod 12, the second end of first connecting rod 12 connected to the clamping mechanism 2; and the drive mechanism 4 is used to to drive the first end of the first connecting rod 12 to perform a circular motion around the drive end end of the drive mechanism 4, so as to cause the second end of the first connecting rod 12 to drive the clamping mechanism 2 to perform a round-trip motion along the guide structure; and a control mechanism, which is connected to the drive mechanism 4 for controlling the drive mechanism to work. For example, the control mechanism may comprise one or more of a PLC programmable controller, a microcomputer, and computer control software. Exemplifically, the control mechanism may be a PLC programmable controller or other control mechanism capable of implementing the above-described logical control, without being specifically limited thereto. It should be noted that the above-described control logic can be implemented using the basic functions of an existing control mechanism. Specifically, the control mechanism is electrically connected or communicatively connected to the drive mechanism 4. Specifically, the drive mechanism 4 serves as a power source, which is usually composed of a motor, hydraulic pump or pneumatic cylinder, etc., and is responsible for providing driving force. The power output end of the motor is the drive end. By adjusting the radius of the circular motion of the first end, that is, the distance between the first end and the drive end, the amplitude of the motion of the second end along the guide structure can be adjusted.

Specifically, in the present disclosure embodiment, the oscillating equipment includes a base, a clamping mechanism, a control mechanism, and a drive mechanism and a limiting mechanism arranged on the base. The base includes a guide structure arranged along a first direction, and the clamping mechanism is arranged on the guide structure and is used to clamp a container containing the reagent to be processed. The reagent to be processed includes a first reagent and a second reagent, and the first direction is perpendicular to the contact surface of the first reagent and the second reagent, so that the two reagents can fully come into contact during the motion of the clamping mechanism during motion, the two reagents can come into sufficient contact; the drive mechanism is connected to the clamping mechanism, the drive mechanism is connected to the first end of the first connecting rod, the second end of the first connecting rod is connected to the clamping mechanism, the drive mechanism is used to drive the first end of the first connecting rod to perform a circular motion around the drive end of the drive mechanism, so that the second end of the first connecting rod drives the clamping mechanism to perform a round-trip motion along the guide structure, replacing manual shaking, which can meet the requirements of high-intensity operations and improve work efficiency; the oscillation amplitude can be adjusted by adjusting the distance between the first end and the drive end, so that high-amplitude oscillations can be achieved. Compared with the characteristic of the elastic force of the limit spring decreasing with the number of oscillations, it can meet the oscillation intensity requirements of long-term experiments, and avoid the situation where the reagent to be processed is not mixed evenly and sufficiently due to insufficient elastic force of the limit spring.

In a possible embodiment, the driving mechanism 4 is connected to the first end of the first connecting rod 12 by means of a second connecting rod 14, the length of the second connecting rod 14 being matched to the amplitude of motion of the clamping mechanism 2.

Specifically, in an embodiment of the present disclosure, a third end of the second connecting rod 14 is connected to a driving end of the driving mechanism 4, and a fourth end of the second connecting rod 14 is connected to a first end of the first connecting rod 12, and when the driving mechanism 4 is operating, the fourth end of the second connecting rod 14 performs a circular motion around the drive end to drive the first end of the first connecting rod 12 to perform a circular motion around the drive end, and the radius of motion is the distance between the third end and the fourth end. In some specific embodiments, when the amplitude needs to be adjusted, it is possible to do so by replacing the second connecting rod 14 of the corresponding specification, and the lengths of the second connecting rods 14 of different specifications are differentiated from each other, and accordingly, the distances between the third end and the fourth end are differentiated from each other.

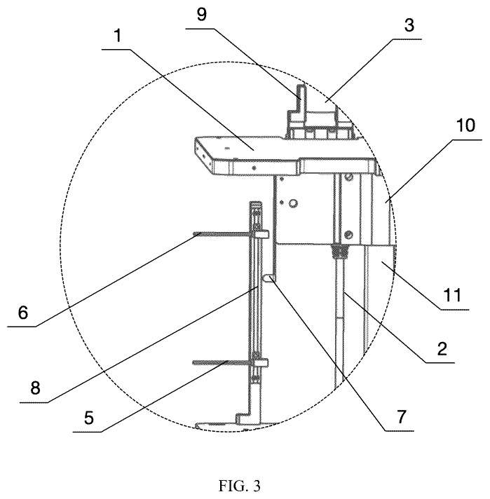

Reference is made to FIG. 3, in a possible embodiment, the oscillating equipment further comprises a limit mechanism provided on the base 1, the limit mechanism comprising a first sensing device 5, the first output signal of the first sensing device 5 indicating that the clamping mechanism 2 is in an operating position, the operating position being a position at which the clamping mechanism 2 completes an action of clamping or releasing the container 3. Specifically, the base 1 comprises a columnar structure arranged in the first direction, the first sensing device 5 is provided on the columnar structure at a location corresponding to the operation position, and when the clamping mechanism 2 is in the operation position, the first sensing device 5 detects the clamping mechanism 2 and outputs the first output signal to indicate that it is convenient to place the container 3 in the clamping mechanism 2 or to remove the container 3 from the clamping mechanism 2. In a specific implementation, in the case where the first direction is a vertical direction, the operating position is usually the highest point of the range of motion of the clamping mechanism 2; the limiting mechanism comprises at least one sensor, and exemplarily, the limiting mechanism comprises a first sensing device 5 and a second sensing device 6, and the first sensing device 5 is distributed with the second sensing device 6 along the first direction, for testing the position of the clamping mechanism 2 in the first direction.

Specifically, in an embodiment of the present disclosure, the limiting mechanism includes a first sensing device, and the first sensing device 5 is used for testing whether the clamping mechanism 2 is in an operating position, so that the first output signal can be obtained when the clamping mechanism 2 is in the operating position to place the container 3 in the clamping mechanism 2 or remove the container 3 from the clamping mechanism 2, so as to facilitate the calibration of the operating position by the host computer to undertake the upper and lower automation processes.

In a possible embodiment, the clamping mechanism 2 is provided with a sliding sheet 7 on a side near the limiting mechanism, the first sensing device 5 is used to output a first output signal when the sliding sheet 7 is sensed, and the location of the first sensing device 5 is matched to the operation position. Specifically, the sliding sheet 7 is provided on the clamping mechanism 2 and is displaced with the motion of the clamping mechanism 2, so that the position of the sliding sheet 7 indicates the position of the clamping mechanism 2, and the sliding sheet 7 extends from the clamping mechanism 2 into the testing range of the first sensing device 5; when the first sensing device 5 corresponding to the first position senses the sliding sheet 7, the first sensing device 5 outputs a first output signal indicating that the clamping mechanism 2 is in the operating position.

Specifically, in the present disclosure embodiment, the clamping mechanism 2 is provided with a sliding sheet 7 on a side near the limiting mechanism, the position of the sliding sheet 7 indicates the position of the clamping mechanism 2, the first sensing device 5 senses that the sliding sheet 7 clamping mechanism 2 is in an operating position, and the first sensing device 5 outputs a first output signal, so that the first output signal can be obtained when the clamping mechanism 2 is in an operating position, so that it is convenient to place the container 3 in the clamping mechanism 2 or to remove the container 3 from the clamping mechanism 2.

In a possible embodiment, the limiting mechanism further comprises a first guide rail 8 arranged in the first direction, and the first sensing device 5 is arranged in the first guide rail 8. Specifically, the base 1 comprises a first mounting plate and a second mounting plate arranged opposite to each other, the first mounting plate being parallel to the second mounting plate, the first guide rail 8 being arranged between the two mounting plates, the first guide rail 8 being perpendicular to the first mounting plate and the second mounting plate, and the first guide rail 8 being parallel to the first direction; the first sensing device 5 is slidably provided on the first guide rail 8 or removably provided on the first guide rail 8, so that the location of the first sensing device 5 relative to the first guide rail 8 can be adjusted. The location corresponding to the first sensing device 5, i.e., the location of the clamping mechanism 2 when the first sensing device 5 senses the sliding sheet 7, is the operation location. In particular embodiments, after adjusting the amplitude, the location of the first sensing device 5 can be adjusted so that the first sensing device 5 outputs a first output signal when the clamping mechanism 2 mechanism is located at the highest point of its range of motion, facilitating the placement of the container 3 in the clamping mechanism 2 or the removal of the container 3 from the clamping mechanism 2.

Specifically, in the present disclosure embodiment, the limiting mechanism comprises a first guide rail 8 arranged along a first direction, and the first sensing device 5 is arranged on the first guide rail 8, so as to facilitate adjustment of the operation position as required by adjusting the position of the first sensing device 5 relative to the first guide rail 8.

In a possible embodiment, the clamping mechanism 2 comprises a clamping assembly 9, the clamping assembly 9 comprising a second guide rail and an oppositely arranged clamping portions, the clamping portions being slidably arranged on the second guide rail, the distance between the oppositely arranged clamping portions matching the size of the container 3. Specifically, the oppositely arranged clamping portions are separately slidably arranged in the second guide rail, and the clamping portions are capable of sliding along the second guide rail, such that the distance between the oppositely arranged clamping portions is capable of varying according to the dimensions of the container 3. In a specific implementation, after the container 3 is placed between the oppositely arranged clamping portions, and the clamping portions are in contact with the container 3, the clamping mechanism 2 provides a clamping force to make the oppositely arranged clamping portions cooperate with each other in clamping the container 3. Specifically, the number of the clamping portions is at least two, e.g., two clamping portions are provided with two clamping portions arranged opposite to each other; and three clamping portions are provided with three clamping portions arranged opposite to each other.

Specifically, in the present disclosure embodiment, the oppositely arranged clamping portions are separately slidably arranged on the second guide rail to constitute the clamping assembly 9, which makes the clamping assembly 9 capable of matching the containers 3 of different specifications by changing the distance between the oppositely arranged clamping portions, and reduces the requirement of the oscillation equipment for the specifications of the containers 3.

In one possible embodiment, the clamping mechanism 2 comprises a plurality of clamping assemblies 9. In embodiments, the initial distances between the pairs of clamping portions of the plurality of clamping assemblies 9 are differentiated from each other, so that they are able to match different sizes of the containers 3 in their initial state.

Specifically, in the present disclosure, a plurality of clamping assemblies 9 are provided to be able to simultaneously clamp a plurality of containers 3 of the same or different specifications for simultaneous oscillation, to improve the oscillation efficiency, and to meet the operational requirements of high-throughput extraction.

In a possible embodiment, the guiding structure comprises a guide post 11 provided in a first direction, the clamping mechanism 2 being provided with a sliding block 10, the sliding block 10 being socketed to the guide post 11.

Specifically, in an embodiment of the present disclosure, the sliding block 10 of the clamping mechanism 2 is set on the guide post 11 provided along the first direction, enabling the clamping mechanism 2 to slide along the first direction. In the specific implementation, the guide post 11 is fixed to the base 1 by a fixing member 13, which can improve the solidity of the guide post 11 and can adapt to a higher oscillation intensity.

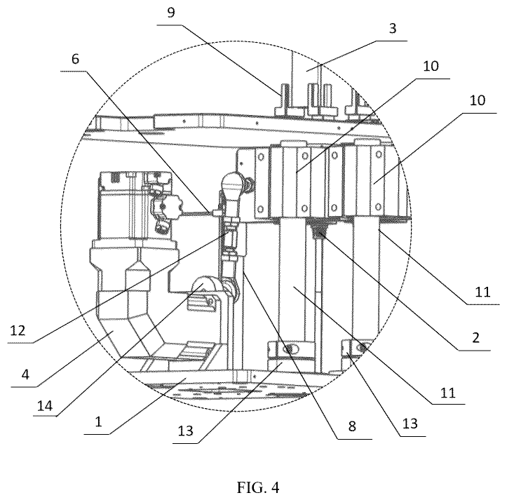

Reference is made to FIG. 4, in a possible embodiment, the drive mechanism 4 is connected to the clamping mechanism 2 via a first connecting rod 12.

Specifically, in the present disclosure, the first connecting rod 12 is used to transfer the force outputted by the driving mechanism 4 to the clamping mechanism 2, as well as to change the direction of the force, so as to make the clamping mechanism 2 move in the first direction.

In a possible embodiment, the control mechanism is also used to regulate the driving speed of the driving mechanism 4.

Specifically, in the present disclosure embodiment, the motion speed of the clamping mechanism 2 is controlled by adjusting the driving speed of the driving mechanism 4, so as to control the oscillation frequency to support low-frequency and high-amplitude oscillations to meet the extraction and separation of some two-phase reagents with large differences in properties, to simulate the commonly used manual extraction and oscillation method in the medicinal and chemical experiments, to reduce the impact of the operation error of the automated equipment on the reaction results, and to ensure the consistency and reproducibility of the experimental data of the automated equipment, and better adapts to different reaction requirements.

In a possible implementation, the clamping mechanism 2 is set to be a plurality, the driving mechanism 4 is set to be a plurality, and the plurality of driving mechanisms 4 correspond to the plurality of clamping mechanisms 2 one by one, each of the driving mechanisms 4 being connected to the corresponding clamping mechanism 2. In a specific implementation, the clamping mechanism 2 may be provided as two, symmetrically distributed in the base 1, and accordingly, the driving mechanism is provided as two, each connected to the corresponding clamping mechanism 2.

Specifically, in the present disclosure, the oscillation and shaking operation of the reagent to be treated is realized by setting up a plurality of sets of clamping mechanism 2, driving mechanism 4 in cooperation, and during operation, the independent oscillation of the corresponding reagent to be treated is realized by controlling the plurality of driving mechanisms 4 to operate independently of each other and controlling the plurality of clamping mechanisms 2 to operate independently of each other.

In summary, the oscillating equipment of the present disclosure comprises a base, a clamping mechanism, a drive mechanism, a limiting mechanism and a control mechanism. The base comprises a guide structure arranged in a first direction, and the clamping mechanism is arranged on the guide structure and is used to clamp a container holding the reagents to be processed. The reagents to be processed comprise a first reagent and a second reagent, and the first direction is perpendicular to the contact surface of the first reagent and the second reagent, so that the two reagents can come into sufficient contact during motion of the clamping mechanism. The drive mechanism is arranged on the base and is connected to the clamping mechanism is connected to drive the clamping mechanism to move along the guide structure, replacing manual shaking and meeting the requirements of high-intensity operations; the limiting mechanism is arranged on the base and is used to output a first output signal when the clamping mechanism is in a first location and to output a second output signal when the clamping mechanism is in a second location. The first location and the second location are arranged opposite each other in the first direction. The oscillation amplitude can be adjusted by adjusting the distance between the first location and the second location, thereby achieving high-amplitude oscillation; and the control mechanism is connected to the drive mechanism and the limiting mechanism, and is used to control the drive mechanism to switch the driving direction when it receives the first output signal or the second output signal, so that the clamping mechanism performs a round-trip motion between the first location and the second location.

In the present disclosure, unless otherwise expressly specified and limited, the terms “connected”, “connect” and the like are to be understood in a broad sense, for example, as a fixed connection, a detachable connection or a one-piece connection, a mechanical connection or an electrical connection; It may be a direct connection or an indirect connection through an intermediate medium, a connection within two elements or an interaction between two elements. For those skilled in the art, the specific meanings of the above terms in the present disclosure may be understood according to the specific circumstances.

It should be noted that the order of the above embodiments of the present disclosure is for description purposes only, and does not indicate any preference. While the above specification describes certain embodiments, other embodiments are also within the scope of the appended Claims. In some cases, the actions or steps recited in the Claims can be performed in a different order in the embodiments and still achieve the intended results. In addition, the processes depicted in the drawings do not necessarily require a specific sequence or be performed in a connected sequence to achieve the intended results, and in some embodiments, parallel processing of multiple tasks is also possible or may be advantageous.

The embodiments in this specification are described in a progressive manner. The similar parts of different embodiments can be cross-referenced, and each embodiment focuses on the differences with other embodiments.

The above is only a better embodiment of the present disclosure, and is not intended to limit the present disclosure, and any modifications, equivalent substitutions, improvements, etc. made within the ideas and principles of the present disclosure shall be included in the scope of protection of the present disclosure.

What is claimed is:

1. An oscillating equipment, comprising:
a base, comprising a guide structure arranged in a first direction;
a clamping mechanism, provided on the guide structure, the clamping mechanism for clamping a container containing reagents to be processed; the reagents to be processed comprising a first reagent and a second reagent, the first direction being perpendicular to a contact surface between the first reagent and the second reagent;
a drive mechanism, provided on the base, the drive mechanism being connected to the clamping mechanism by means of a first connecting rod; the drive mechanism being connected to a first end of the first connecting rod, a second end of the first connecting rod being connected to the clamping mechanism, and the drive mechanism being used to drive the first end of the first connecting rod to perform a circular motion around a drive end of the drive mechanism, so as to cause the second end of the first connecting rod to drive the clamping mechanism to perform a round-trip motion along the guide structure; and
a control mechanism, which is connected to the drive mechanism for controlling the drive mechanism to work.

2. The equipment according to claim 1, wherein the drive mechanism is connected to the first end of the first connecting rod by means of a second connecting rod, a length of the second connecting rod being matched to the motion of the clamping mechanism.

3. The oscillating equipment according to claim 1, further comprising:
a limiting mechanism, provided on the base, wherein the limiting mechanism includes a first sensing device, with a first output signal of the first sensing device indicating that the clamping mechanism is in an operative position, the operative position being the position at which the clamping mechanism completes an action of clamping or releasing the container.

4. The oscillating equipment according to claim 3, wherein the clamping mechanism is provided with a sliding sheet on a side close to the limiting mechanism, and the first sensing device is used for outputting the first output signal when it senses the sliding sheet, and the position of the first sensing device is matched with the operating position.

5. The oscillating equipment according to claim 4, wherein the limiting mechanism further comprises a first slide rail arranged along with the first direction, the first sensing device being arranged on the first slide rail.

6. The oscillating equipment according to claim 1, wherein the clamping mechanism comprises a clamping assembly, the clamping assembly comprising a second slide rail and oppositely arranged clamping portions, the clamping portions being slidably arranged on the second slide rail, with a distance between the oppositely arranged clamping portions matched to the dimensions of the container.

7. The oscillating equipment according to claim 6, wherein the clamping mechanism comprises a plurality of the clamping assemblies.

8. The oscillating equipment according to claim 1, wherein the guide structure comprises a guide post provided in the first direction, the clamping mechanism being provided with a sliding block, the sliding block being socketed to the guide post.

9. The oscillating equipment according to claim 1, wherein the control mechanism is further used to regulate a driving speed of the drive mechanism.

10. The oscillating equipment according to claim 1, wherein the clamping mechanism is provided in a plurality, the drive mechanism is provided in a plurality, and a plurality of the drive mechanisms corresponds to a plurality of the clamping mechanisms, with each drive mechanism coupled to a corresponding clamping mechanism.
